(19) United States
(12) Patent Application Publication
(10) Pub. No.: US 2021/0402616 A1
(43) Pub. Date: Dec. 30, 2021

(54) INFORMATION PROCESSING APPARATUS, INFORMATION PROCESSING METHOD, MOBILE ROBOT, AND NON-TRANSITORY COMPUTER-READABLE STORAGE MEDIUM

(71) Applicant: CANON KABUSHIKI KAISHA, Tokyo (JP)

(72) Inventors: Hisayoshi Furihata, Tokyo (JP); Shinji Ohira, Tokyo (JP)

(21) Appl. No.: 17/361,048

(22) Filed: Jun. 28, 2021

(30) Foreign Application Priority Data
Jun. 30, 2020 (JP) 2020-113197

(51) Int. Cl. B25J 13/08; G05D 1/00; B25J 9/16; G05D 1/02

(52) U.S. Cl. CPC B25J 13/089; G05D 1/0044; G05D 1/0246; B25J 9/162; G05D 1/0219; B25J 9/1697

(57) ABSTRACT

An information processing apparatus comprises an obtainment unit configured to obtain sensor information which is a result obtained by a sensor, mounted in a mobile robot, sensing an actual space and a position and a posture of the sensor in the sensing, an estimation unit configured to set, as an index, the sensor information and/or the position and the posture obtained by the obtainment unit and estimate, based on a newly obtained index and an index which has been obtained in the past and is similar to the newly obtained index, a progress status of an operation for obtaining pieces of sensor information including pieces of sensor information of a closed path; and an output unit configured to output the progress status estimated by the estimation unit.

### BACKGROUND

### Field of the Disclosure

The present disclosure relates to a technique for generating map information.

### Description of the Related Art

SLAM (Simultaneous Localization And Mapping) is a technique in which a sensor such as a camera or the like is moved to estimate a position and a posture of the sensor or the map information of a peripheral environment. In M. A. Raul, J. M. M. Montiel and J. D. Tardos., ORB-SLAM: A Versatile and Accurate Monocular SLAM System, Trans. Robotics vol. 31, 2015, a technique called loop closing is disclosed as a method for estimating highly accurate map information. In loop closing, highly accurate map information is estimated by recognizing a loop-shaped section (closed path) on a path on which a sensor has been moved and adding, as a constraint, the continuity of a map in the closed path.

Since an operator who is to perform image capturing while moving a sensor to estimate the map information of the peripheral environment of the sensor is unable to know whether image capturing data that includes image capturing data of a closed path has been obtained during the imaging capturing operation, the execution of loop closing can be unreliable. Therefore, it is difficult to obtain highly accurate map information.

### SUMMARY

The present disclosure provides a technique for obtaining highly accurate map information.

According to the first aspect of the present disclosure, there is provided an information processing apparatus comprising: an obtainment unit configured to obtain sensor information which is a result obtained by a sensor, mounted in a mobile robot, sensing an actual space and a position and a posture of the sensor in the sensing; an estimation unit configured to set, as an index, the sensor information and/or the position and the posture obtained by the obtainment unit and estimate, based on a newly obtained index and an index which has been obtained in the past and is similar to the newly obtained index, a progress status of an operation for obtaining pieces of sensor information including pieces of sensor information of a closed path; and an output unit configured to output the progress status estimated by the estimation unit.

According to the second aspect of the present disclosure, there is provided a mobile robot, comprising: an information processing apparatus including an obtainment unit configured to obtain sensor information which is a result obtained by a sensor, mounted in the mobile robot, sensing an actual space and a position and a posture of the sensor in the sensing, an estimation unit configured to set, as an index, the sensor information and/or the position and the posture obtained by the obtainment unit and estimate, based on a newly obtained index and an index which has been obtained in the past and is similar to the newly obtained index, a progress status of an operation for obtaining pieces of sensor information including pieces of sensor information of a closed path, and an output unit configured to output the progress status estimated by the estimation unit; and the sensor.

According to the third aspect of the present disclosure, there is provided an information processing method, comprising: obtaining sensor information which is a result obtained by a sensor, mounted in a mobile robot, sensing an actual space and a position and a posture of the sensor in the sensing; setting the obtained sensor information and/or the obtained position and the posture as an index and estimating, based on a newly obtained index and an index which has been obtained in the past and is similar to the newly obtained index, a progress status of an operation for obtaining pieces of sensor information including pieces of sensor information of a closed path; and outputting the estimated progress status.

According to the fourth aspect of the present disclosure, there is provided a non-transitory computer-readable storage medium storing a computer program for causing a computer to function as perform an information processing method, the method comprising: obtaining sensor information which is a result obtained by a sensor, mounted in a mobile robot, sensing an actual space and a position and a posture of the sensor in the sensing; setting the obtained sensor information and/or the obtained position and the posture as an index and estimating, based on a newly obtained index and an index which has been obtained in the past and is similar to the newly obtained index, a progress status of an operation for obtaining pieces of sensor information including pieces of sensor information of a closed path; and outputting the estimated progress status.

Further features of the present disclosure will become apparent from the following description of exemplary embodiments (with reference to the attached drawings).

### BRIEF DESCRIPTION OF THE DRAWINGS

FIG. 1 is a view showing the arrangement of a system;

FIG. 2 is a block diagram showing an example of the arrangement of a mobile robot;

FIG. 3 is a block diagram showing an example of the functional arrangement of an information processing apparatus 500;

FIG. 4 is a flowchart showing an operation of the information processing apparatus 500; and

FIG. 5 is a block diagram showing an example of the hardware arrangement of a computer apparatus.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made to a disclosure that requires all such features, and multiple such features may be combined as appropriate. Furthermore, in the attached drawings, the same reference numerals are given to the same or similar configurations, and redundant description thereof is omitted.

### First Embodiment

Generally in SLAM, two-dimensional images and three-dimensional data are continuously obtained from a sensor to estimate the position and the posture of the sensor and the map information of a peripheral environment of the sensor. A phenomenon (drifting) in which errors included in the map information increase in accordance with the amount of movement of the sensor is known as a problem of SLAM.

To suppress the influence of drifting, a function called loop closing is used. In loop closing, highly accurate map information is estimated by recognizing a closed path on the path on which a sensor has moved and adding, as a constraint, the continuity of the map in the closed path. In the aforementioned M. A. Raul, J. M. M. Montiel and J. D. Tardos., ORB-SLAM: A Versatile and Accurate Monocular SLAM System, Trans. Robotics vol. 31, 2015, a method of executing loop closing based on image capturing data including image capturing data of a closed path is disclosed.

To generate highly accurate map information, whether loop closing can be executed in a state in which the aforementioned influence of drifting is suppressed becomes important. However, it is difficult to determine whether image capturing data including image capturing data of a closed path has been obtained at the time when a user is performing an image capturing operation.

Hence, in this embodiment, the progress status of the operation for obtaining captured images including captured images of a closed path is estimated, and the user is notified of the estimated progress status. The progress status of the operation represents the degree to which the completion of the operation has been achieved, and may also be called a degree of achievement hereinafter. The user can determine whether to end the image capturing operation by viewing this progress status. Since this will allow captured images that include captured images of the closed path to be reliably obtained and loop closing to be executed based on the obtained captured images, highly accurate map information can be obtained. A more specific arrangement and procedure of this embodiment will be described hereinafter.

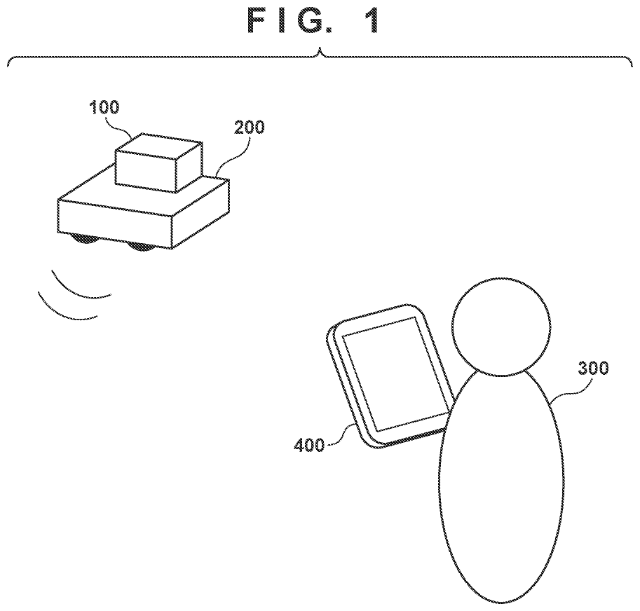

First, the arrangement of a system according to this embodiment will be described with reference to FIG. 1. As shown in FIG. 1, the system according to this embodiment includes a terminal device 400, and a mobile robot 200 that moves in accordance with an operation on the terminal device 400 by a user 300. Furthermore, an image capturing apparatus 100 that continuously captures images is arranged on the mobile robot 200. In this embodiment, map information of an environment is estimated (generated) based on images captured by the image capturing apparatus 100 while the mobile robot 200 is moving.

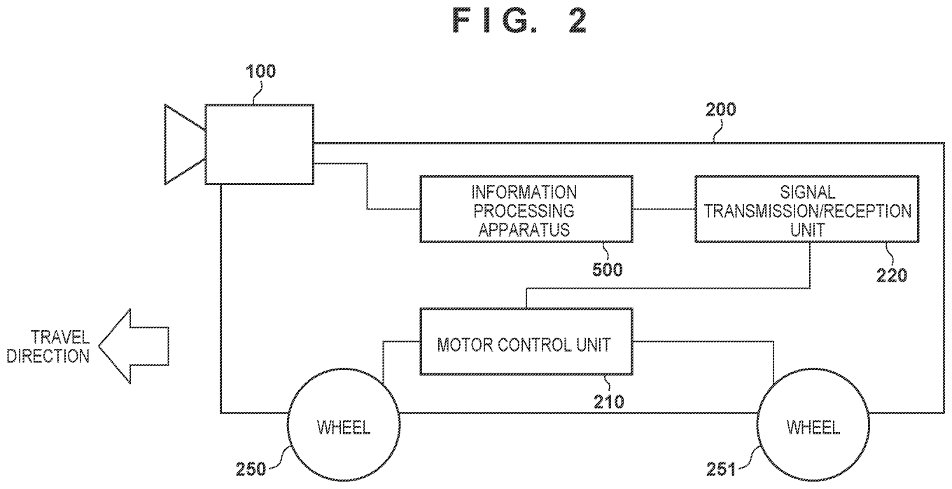

An example of the arrangement of the mobile robot will be described next with reference to the block diagram of FIG. 2. As described above, the image capturing apparatus 100 is an apparatus that performs continuous image capturing, and each of the continuously captured images is input to an information processing apparatus 500.

The information processing apparatus 500 estimates (generates) the map information of the environment based on the captured images continuously input from the image capturing apparatus 100, and estimates the progress status of the operation for obtaining the captured images including the captured images of the closed path.

A signal transmission/reception unit 220 performs data communication with the terminal device 400. For example, when the user 300 operates the terminal device 400 and inputs a move instruction to move the mobile robot 200, the terminal device 400 will use wireless communication to transmit, to the mobile robot 200, a signal (move instruction signal) including the move instruction. The signal transmission/reception unit 220 will receive the move instruction signal transmitted from the terminal device 400 via wireless communication, and output the received move instruction signal to a motor control unit 210. The signal transmission/reception unit 220 will also transmit, to the terminal device 400, a signal (notification signal) including the progress status estimated by the information processing apparatus 500. The terminal device 400 will receive the notification signal and display a screen based on the progress status included in the notification signal. The signal transmission/reception unit 220 will also transmit, to the terminal device 400, a signal (map information signal) including the map information generated by the information processing apparatus 500. The terminal device 400 will receive the map information signal and display a screen based on the map information included in the map information signal.

The motor control unit 210 controls the speed of movement and the direction of movement of the mobile robot 200 by performing, based on the move instruction signal output from the signal transmission/reception unit 220, driving control of motors for controlling wheels 250 and 251 included in the mobile robot 200.

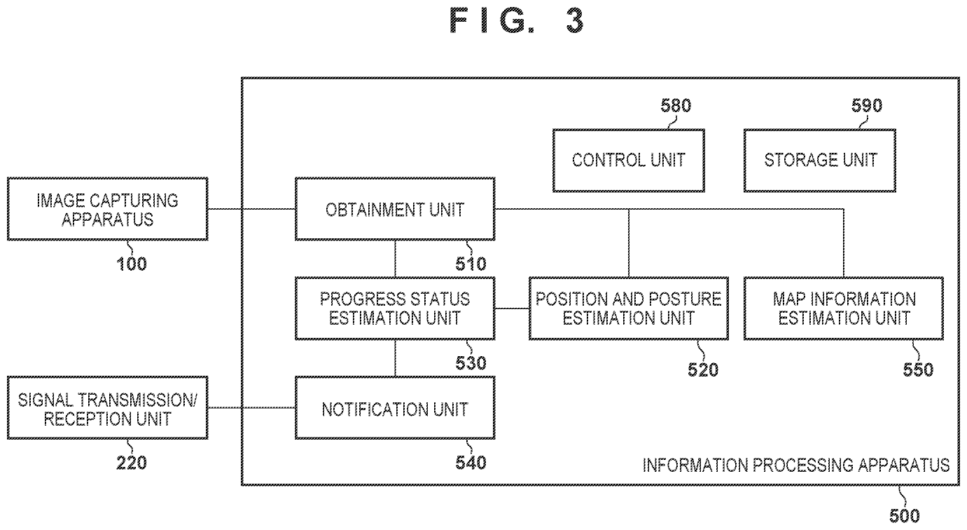

An example of the functional arrangement of the above-described information processing apparatus 500 will be described next with reference to a block diagram of FIG. 3. An obtainment unit 510 obtains each captured image output from the image capturing apparatus 100 when the image capturing apparatus 100 continuously performs image capturing. A position and posture estimation unit 520 estimates, by using each captured image obtained by the obtainment unit 510, the position and the posture of the image capturing apparatus 100 at the time when the image was captured.

A progress status estimation unit 530 sets each captured image obtained by the obtainment unit 510 and/or each position and each posture estimated by the position and posture estimation unit 520 as an index and estimates, based on a latest index and a past index which has a predetermined relationship with the latest index, the progress status of the operation for obtaining captured images that include captured images the closed path.

A map information estimation unit 550 estimates the map information of an environment based on each captured image obtained by the obtainment unit 510 and each position and each posture of the image capturing apparatus 100 estimated, based on the corresponding captured image, by the position and posture estimation unit 520. The map information is information in which feature points detected from a captured image obtained by the obtainment unit 510 and a position and a posture of the image capturing apparatus 100 at the time when the image was captured have been registered in association with each other. Note that in a case in which the position and the posture of the image capturing apparatus 100 are to be estimated from a newly captured image after the map information has been estimated, feature points that correspond to feature points detected from the newly captured image will be specified among the feature points included in the map information. Subsequently, the position and the posture of the image capturing apparatus 100 at the time when the newly captured image was captured are estimated based on the position and the posture of the image capturing apparatus 100 associated with the corresponding feature points of the map information.

A notification unit 540 outputs, to the signal transmission/reception unit 220, the progress status estimated by the progress status estimation unit 530 and the map information estimated by the map information estimation unit 550. As a result, the signal transmission/reception unit 220 generates a signal including the progress status or a signal including the map information and transmits the generated signal to the terminal device 400.

A control unit 580 controls the overall operation of the information processing apparatus 500. A storage unit 590 stores computer programs and data related to processing operations (to be described later). The computer programs and data stored in the storage unit 590 are used by other functional units to execute respective processing operations to be described below.

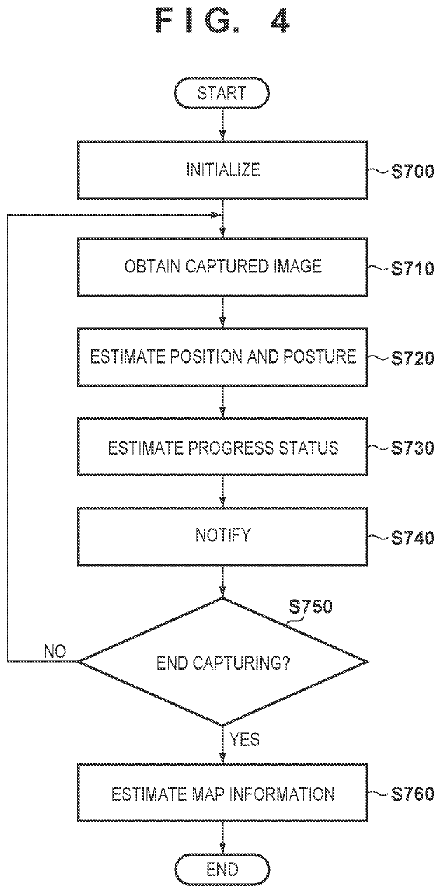

The operation of the information processing apparatus 500 will be described next in accordance with the flowchart of FIG. 4. Note that processing according to the flowchart of FIG. 4 is executed while the mobile robot 200 is moving.

In step S700, the control unit 580 executes initialization processing. In the initialization processing, a computer program and data stored in the storage unit 590 are read out. The data stored in the storage unit 590 includes camera parameters and the like of the image capturing apparatus 100.

In step S710, the obtainment unit 510 obtains each captured image output from the image capturing apparatus 100 and stores each obtained captured image in the storage unit 590.

In step S720, the position and posture estimation unit 520 estimates, based on each captured image obtained by the obtainment unit 510 in step S710, the position and the posture of the image capturing apparatus 100 at the time when the image was captured, and stores the estimated position and the estimated posture of the image capturing apparatus 100 in the storage unit 590. The technique for estimating the position and the posture of the image capturing apparatus 100 that captured the image from the captured image is well known. For example, the method disclosed in the aforementioned M. A. Raul, J. M. M. Montiel and J. D. Tardos., ORB-SLAM: A Versatile and Accurate Monocular SLAM System, Trans. Robotics vol. 31, 2015 can be used. In M. A. Raul, J. M. M. Montiel and J. D. Tardos., ORB-SLAM: A Versatile and Accurate Monocular SLAM System, Trans. Robotics vol. 31, 2015, feature points are detected from images and associated between images to estimate the position and the posture of a sensor (the image capturing apparatus 100 in this embodiment).

In step S730, the progress status estimation unit 530 estimates, based on “the positions of the image capturing apparatus 100 estimated by the position and posture estimation unit 520 in the past” stored in the storage unit 590, the progress status of the operation for obtaining the captured images including the captured images the closed path.

For example, the progress status estimation unit 530 sets, as a position Qs, the latest estimated position among “the positions of the image capturing apparatus 100 estimated by the position and posture estimation unit 520 in the past” stored in the storage unit 590. The progress status estimation unit 530 also sets, as a position Qt, a position with the shortest distance to the position Qs among “the positions of the image capturing apparatus 100 estimated by the position and posture estimation unit 520 in the past” stored in the storage unit 590. Subsequently, the progress status estimation unit 530 obtains a distance D between the position Qs and the position Qt, and estimates, based on the obtained distance D, “a progress status (degree of achievement) X of the operation for obtaining the captured images including the captured images of the closed path”. The progress status (degree of achievement) X can be obtained to decrease as the distance D increases and increase as the distance D decreases. For example, the progress status X can be obtained based on an equation such as X=−D or X=1/D or the like. That is, it will be estimated that the progress status (degree of achievement) X of an operation is high by assuming, as the distance D decreases, that “a closed path has been formed near a point that was passed by the mobile robot 200 in the past”.

In step S740, the notification unit 540 outputs, to the signal transmission/reception unit 220, the progress status (degree of achievement) X estimated in step S730. As described above, the signal transmission/reception unit 220 transmits a notification signal including the progress status (degree of achievement) X to the terminal device 400.

Upon receiving the notification signal from the mobile robot 200, the terminal device 400 displays a screen based on the progress status (degree of achievement) X included in the notification signal. For example, the progress status (degree of achievement) X (numerical value) may be directly displayed as a character string or a graph such as a bar chart or a pie chart expressing the numerical value may be displayed in the screen based on the progress status (degree of achievement) X. Alternatively, the progress status (degree of achievement) X may undergo threshold processing and a corresponding evaluation result, such as “GOOD” when the progress status (degree of achievement) X is equal to or greater than a threshold or “NP_LOOP” when the progress status (degree of achievement) X is less than a threshold, may be displayed.

In step S750, the control unit 580 determines whether the completion condition for ending the image capturing operation by the image capturing apparatus 100 has been satisfied. For example, in a case in which the user 300 has input an image capturing completion instruction upon seeing the progress status displayed in the terminal device 400, the terminal device 400 will transmit, to the mobile robot 200, a signal (end instruction signal) including the image capturing completion instruction. Since the signal transmission/reception unit 220 will output, upon receiving the end instruction signal, the end instruction signal to the control unit 580, the control unit 580 will determine that the completion condition has been satisfied and control the image capturing apparatus 100 to stop the image capturing operation.

As a result of the above-described determination, if it is determined that the completion condition has been satisfied, the process will advance to step S760. If it is determined that the completion condition has not been satisfied, the process will advance to step S710 and the image capturing operation will be continued.

In step S760, the map information estimation unit 550 estimates the map information based on the captured images and the corresponding positions and postures of the image capturing apparatus 100 stored in the storage unit 590. A known method can be used for the estimation method of the map information. For example, in M. A. Raul, J. M. M. Montiel and J. D. Tardos., ORB-SLAM: A Versatile and Accurate Monocular SLAM System, Trans. Robotics vol. 31, 2015, a method of estimating the map information based on feature points of an image captured at each point in time is disclosed.

In this manner, in this embodiment, the progress status of the operation for obtaining captured images of capturing images of the closed path is estimated based on the position of the image capturing apparatus 100 on the path, and the user is notified of the estimated progress status. The user can see the notified progress status to determine whether to end the image capturing operation. As a result, captured images including capturing images of the closed path can be reliably obtained, and highly accurate map information can be obtained by executing loop closing.

### Second Embodiment

Only differences from the first embodiment will be described in each of the embodiments and the modifications including this embodiment to be described hereinafter. Assume that arrangements are similar to those of the first embodiment unless otherwise mentioned below. In the first embodiment, a progress status estimation unit 530 estimated the progress status based on a distance D between image capturing positions on a path. However, any method may be used as a method of estimating the progress status as long as one of the image capturing position and the captured image is used to obtain the degree in which a path on which an image capturing apparatus 100 has moved has been closed, and the user can be notified of this obtained degree as the progress status of operation completion.

In this embodiment, a method of obtaining the progress status based on the similarity of captured images on the path will be described as an example of a method of obtaining the progress status based on captured images. More specifically, in step S730, the progress status estimation unit 530 will estimate, based on “captured images obtained by an obtainment unit 510 in the past” stored in a storage unit 590, the progress status of the operation for obtaining the captured images including the captured images the closed path.

For example, the progress status estimation unit 530 sets, as a captured image Ps, the latest captured image among “the captured images obtained by the obtainment unit 510 in the past” stored in the storage unit 590. In addition, the progress status estimation unit 530 sets, as a captured image Pt, a captured image with the highest similarity to the captured image Ps among “the captured images obtained by the obtainment unit 510 in the past” stored in the storage unit 590. This “similarity” may be defined based on an SSD described below or defined based on an SAD described below, and the similarity between the images can be obtained by any method. The progress status estimation unit 530 can obtain the SSD (Sum of Squared Difference) between the captured image Ps and the captured image Pt, and obtain a similarity M between the captured image Ps and the captured image Pt based on the obtained SSD. Since the value of the SSD will decrease as the similarity between the images increases, the progress status estimation unit 530 can obtain the similarity M by calculating, for example, M=−SSD. Subsequently, the progress status estimation unit 530 will obtain the progress status (degree of achievement) X so that it will increase as the similarity M increases and decrease as the similarity M decreases. For example, the progress status estimation unit 530 sets the progress status (degree of achievement) X to be X=M. That is, it will be assumed that “the closed path has been formed near points passed by a mobile robot 200 in the past” as the similarity M increases, and the degree of progress (degree of achievement) of the operation will be estimated to be high.

Note that although the similarity M is obtained based on the SSD between the captured image Ps and the captured image Pt in this embodiment, the method of obtaining the similarity M between the captured image Ps and the captured image Pt is not limited to such a method. For example, the similarity M may be obtained based on an SAD (Sum of Absolute Difference) between the captured image Ps and the captured image Pt. Also, in two similar images, corresponding feature points (feature points with similar feature amounts) between the two images tend to be detected. This tendency may be used to detect the feature points from the captured image Ps and the captured image Pt so that the similarity M will be increased as the number of corresponding feature points increases between the captured image Ps and the captured image Pt. In this case, for example, letting N be the number of corresponding feature points, the similarity M=N. Alternatively, other than using the number of corresponding feature points, the similarity between the captured images may be obtained based on the similarity of arrangements of the feature points or the like. In any case, the progress status (degree of achievement) X will be set as X=M.

In this manner, according to this embodiment, the progress status of the operation for obtaining captured images including captured images of the closed path is estimated based on the captured images of the path, and the user is notified of the estimated progress status. The user can see this notified progress status and determine whether to end the image capturing operation. As a result, captured images including captured images of the closed path can be reliably obtained, and highly accurate map information can be obtained by executing loop closing.

Note that the progress status may be obtained based on both captured images and the positions of the image capturing apparatus 100. That is, the progress status (degree of achievement) X may be obtained by calculating X=f(D, M)=(−D)+k x M. Here, assume that k is a coefficient for obtaining the ratio of D and M, and is a value set in advance. Note that since various kinds of equations can be considered for the equation expressing the relationship between the progress status (degree of achievement) X and the distance D and the equation expressing the relationship between the progress status (degree of achievement) X and the similarity M as described above, a function applicable as a function f is not limited to a specific function described above.

### Third Embodiment

By arranging a mobile robot 200 in the following manner, an autonomous mobile robot can be formed. Map information estimated by a map information estimation unit 550 is stored in a storage unit 590. A position and posture estimation unit 520 estimates the positions and the postures of the mobile robot 200 in an actual space based on captured images obtained by an obtainment unit 510 and the map information stored in the storage unit 590. This estimation method is a known method, and the method proposed in, for example, M. A. Raul, J. M. M. Montiel and J. D. Tardos., ORB-SLAM: A Versatile and Accurate Monocular SLAM System, Trans. Robotics vol. 31, 2015 can be used. A path planning unit is newly added to the information processing apparatus 500. The path planning unit calculates a control value to be used next based on the position and the posture estimated by the position and posture estimation unit 520 and outputs the control value to a motor control unit 210 so that the mobile robot can move in accordance with a preset target route. This control value is the control amount of the motor to be used for moving to the next destination, and the motor control unit 210 will move the mobile robot 200 by controlling the motor based on the control value.

The accuracy of the position and the posture to be estimated here depends on the accuracy of the map information. Since captured images that can be used to execute loop closing can be obtained in a case in which the image capturing completion determination is to be performed based on the notification method according to this embodiment, it will be possible to obtain highly accurate map information. That is, the accuracy can be improved when the position and the posture of an image capturing apparatus 100 are to be estimated by using this map information. If the position and the posture can be estimated highly accurately, the mobile robot will be able to move autonomously with high accuracy.

### Fourth Embodiment

In the first embodiment, the progress status is estimated in step S730, progress status notification is performed in step S740, whether the image capturing completion condition has been satisfied is determined in step S750, and map information estimation is performed in step S760 after the completion of image capturing. However, the map information estimation timing is not limited to such an estimation timing, and may be, for example, any timing as long as it is a timing after the closed path has been formed and the value representing the progress status has become equal to or higher than a reference value.

For example, after the progress status has been estimated in step S730, the map information estimation of step S760 may be performed if the value representing the progress status is equal to or higher than the reference value. Alternatively, instead of generating map information immediately after the completion of the image capturing operation, it may be arranged so that map information will be generated when map information generation has been instructed by a user after the completion of the processing (however, the process of step S760 will be omitted) according to the flowchart of FIG. 4.

Subsequently, in accordance with this process, the progress status notification timing may be set so that notification will be performed immediately after the progress status has been estimated as described in the first embodiment or so that notification will be performed after the map information has been estimated. The timing of progress status notification is not limited to a particular timing.

### <First Modification>

Similar captured images may be continuously output from an image capturing apparatus 100 depending on the movement of a mobile robot 200 (for example, a case in which the speed of movement of the mobile robot 200 is slow). In such a case, a similarity M between the captured images will increase, and the user will be notified that the progress status is at a high level even though the mobile robot 200 has not yet moved along the loop-shaped closed path.

In a similar manner, a position and posture estimation unit 520 may continuously estimate similar positions and postures depending on the movement of a mobile robot 200 (for example, a case in which the speed of movement of the mobile robot 200 is slow). In such a case, the distance between image capturing positions will decrease, and the user will be notified that the progress status is at a high level even though the mobile robot 200 has not yet moved along the loop-shaped closed path.

In order to avoid such states, the progress status will be obtained only in a case in which the distance of movement of the mobile robot 200 has exceeded a predetermined reference value B, and the progress status will not be obtained unless the distance of movement of the mobile robot 200 has exceeded the reference value B. The distance of movement of the mobile robot 200 can be obtained from the positions of the image capturing apparatus 100 stored in the storage unit 590. For example, if a position 1, a position 2, . . . and a position i (i is an integer of 3 or more) are stored according to the movement order in the storage unit 590 (the position i is the latest position), a distance L can be obtained as a sum total of results obtained by calculating |position x−position (x−1)| for each of x=2 to i.

### <Second Modification>

Although the image capturing apparatus 100 has been described as an example of a sensor for capturing images of an actual space in the embodiments and the modification described above, any kind of sensor may be used as long as it is an apparatus that collects two-dimensional sensing results of an actual space.

In addition, the embodiments and the modification described above can be implemented in a similar manner by using three-dimensional sensing results of an actual space (three-dimensional point groups of an actual space) instead of the two-dimensional sensing results of the actual space. In a case in which the three-dimensional sensing results of the actual space are to be used instead of the two-dimensional sensing results of the actual space, the image capturing apparatus 100 may be a stereo camera or a sensor that collects the three-dimensional point groups of the actual space. For example, a sensor such as a distance sensor or LiDAR is applicable as the sensor for collecting the three-dimensional point groups of the actual space. The position and posture estimation method and the map information estimation method using the three-dimensional point groups employ known methods as disclosed in, for example, the following literature.

M. Keller, D. Lefloch, M Lambers, S. Izadi, T. Weyrich, A. Kolb, “Real-time 3D Reconstruction in Dynamic Scenes using Point-based Fusion”, International Conference on 3D Vision (3DV), 2013

In this literature, the position and the posture of the sensor are estimated by matching the three-dimensional point groups obtained at respective points in time. Subsequently, the map information of an environment is estimated by integrating, in accordance with each position and each posture of the sensor, the three-dimensional point group obtained at each point in time. As described above, since the position and the posture of the sensor at each point in time can be estimated based on the three-dimensional point group obtained at each point in time, progress status estimation based on the position of the image capturing apparatus 100 can be performed as shown in the first embodiment. In addition, the progress status can be estimated based on the similarity between the three-dimensional point groups instead of the similarity between captured images. For example, matching of three-dimensional point groups which have been collected at adjacent timings can be performed, and the ratio of the number of matching three dimensional points between one three-dimensional point group and the other three-dimensional point group can be set as the similarity between three-dimensional point groups. For example, ICP (Iterative Closest Point) can be employed as a method for executing matching of the three-dimensional point groups.

That is, the information processing apparatus 500 will obtain pieces of sensor information as a result obtained by performing sensing operations in the actual space while moving a sensor and the positions and the postures of the sensor during the sensing operations, set the pieces of sensor information and/or the positions and the postures as indices, and estimate, based on the latest index and a past index which has a predetermined relationship with the latest index, the progress status of the operation for obtaining pieces of sensor information including pieces of sensor information of the closed path.

The map information is information that includes geometric information of a peripheral environment estimated from the pieces of sensor information. More specifically, in a case in which the pieces of sensor information are two-dimensional images, the map information will include the positional information of feature points of an object detected from captured images of respective points in time. In a case in which the pieces of sensor information are three-dimensional point groups, the map information will include the three-dimensional point groups of the entire environment obtained by integrating the three-dimensional point groups of respective points in time or a plurality of three-dimensional point groups.

In the third embodiment, the mobile robot 200 performs autonomous travel by estimating, based on this map information, the position and the posture of the image capturing apparatus 100 mounted in the mobile robot 200. In case in which the image capturing apparatus 100 is a camera that obtains two-dimensional captured images and the map information is information of feature points of two-dimensional captured images, the position and the posture of the mobile robot 200 in the actual space can be estimated by performing feature point association between the map information and the two-dimensional captured images. On the other hand, in a case in which the image capturing apparatus 100 is a sensor that collects three-dimensional sensing results and the map information is three-dimensional point groups of the environment, the position and the posture of the mobile robot 200 in the actual space can be estimated by performing matching of the three-dimensional point groups.

### <Third Modification>

The position and posture estimation method of the image capturing apparatus 100 is not limited to a specific estimation method. For example, the feature points detected from a captured image can be used to estimate the position and the posture of the image capturing apparatus 100 that obtained the captured image. In addition, in a case in which a sensor that collects three-dimensional point groups in an actual space is to be used as the image capturing apparatus 100, the position and the posture of the image capturing apparatus 100 may be estimated by matching the three-dimensional point groups. Alternatively, an IMU (Inert Measurement Unit) may be arranged in the image capturing apparatus 100, and the position and the posture of the image capturing apparatus 100 may be estimated based on the IMU. The position and the posture of the image capturing apparatus 100 may also be estimated by using a GPS. Furthermore, an index such as an AR marker or the like with an already known shape may be arranged in the environment, and a captured image of the index may be used to estimate the position and the posture of the image capturing apparatus 100 that obtained the captured image.

### <Fourth Modification>

In the embodiments and the modifications described above, a user 300 of a terminal device 400 is notified of the progress status by notifying the terminal device 400 of the progress status. However, the progress status notification destination is not limited to the terminal device 400. In addition, the progress status notification method is not limited to a specific notification method.

For example, the progress status notification can be transmitted to a notification apparatus which can generate stimulation so that the state of progress (the magnitude of the degree of achievement) will be detectable by senses such as the audio-visual senses and the tactile sense. Such a notification apparatus may be a loudspeaker that outputs a sound, a monitor that outputs characters and images, or an apparatus that performs progress status notification by turning an LED on and off.

In addition, the notification may be performed by changing a degree such as the magnitude of the notification in accordance with the progress status. For example, the notification can be performed by changing the magnitude of the sound to be output, the size of characters to be displayed, the color of the characters, the type of the characters, the intensity of light to be displayed, or the like.

### Fifth Example

In the embodiments and the modifications described above, the progress status estimation is performed without limiting the execution of the estimation to a specific location. However, the location where the progress status estimation is to be performed may be determined in advance. For example, consider a case in which image capturing is to be performed by the image capturing apparatus 100 while the mobile robot 200 is moving on a path of movement in which it will move from a location F and return again to the location F. Assume here that the location F is a progress status estimation target location.

In such a case, a progress status estimation unit 530 will set, as a position Q0, the position of the image capturing apparatus 100 in the location F and set, as a position Qs, the latest estimated position among “the positions of the image capturing apparatus 100 estimated by the position and posture estimation unit 520 in the past” stored in the storage unit 590. Subsequently, the progress status estimation unit 530 will obtain a distance D between the position Q0 and the position Qs, and estimate, based on the obtained distance D, a “progress status (degree of achievement) X of the operation for obtaining captured images including captured images of the closed path” in a manner similar to the first embodiment.

Note that as another example, the progress status estimation unit 530 can set, as a captured image P0, a captured image obtained by the image capturing apparatus 100 in the location F, and set, as a captured image Ps, the latest captured image among the “captured images obtained by an obtainment unit 510 in the past” stored in the storage unit 590. Subsequently, the progress status estimation unit 530 can obtain the similarity between the captured image P0 and the captured image Ps in a manner similar to the first embodiment, and obtain the progress status (degree of achievement) X based on the obtained similarity.

Furthermore, the progress status may be obtained based on both the distance D between the position Q0 and the position Qs and the similarity between the captured image P0 and the captured image Ps in a manner similar to the second embodiment in this embodiment as well.

Such a method of obtaining the progress status (degree of achievement) X can suppress the calculation cost of obtaining the progress status (degree of achievement) X because a search for a pair of positions or a pair of captured images (a pair for obtaining the distance D or a pair for obtaining the similarity between images) on the path need not be performed.

### Fifth Embodiment

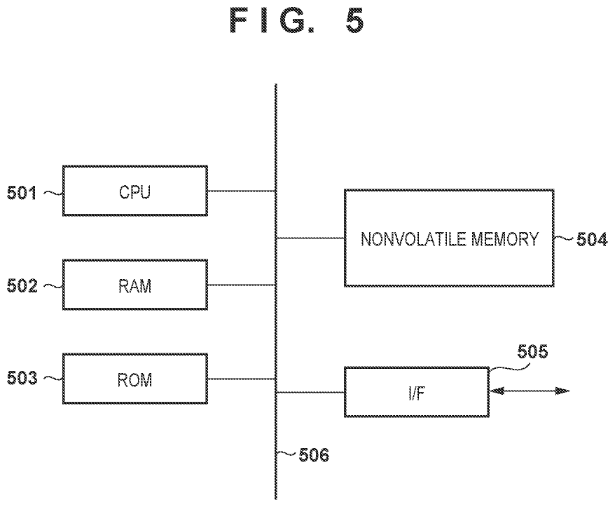

Although functional units of an information processing apparatus 500 shown in FIG. 3 may be implemented by hardware, the functional units other than a storage unit 590 may also be implemented by software (computer programs). In the case of the latter, a computer apparatus that can execute these computer programs can be applied as the information processing apparatus 500. An example of the hardware arrangement of the computer apparatus that can be applied as the information processing apparatus 500 will be described with reference to the block diagram of FIG. 5.

A CPU 501 executes various kinds of processing by using computer programs and data stored in a RAM 502 and a ROM 503. This will allow the CPU 501 to control the overall operation of the information processing apparatus 500 and execute or control the various kinds of processing described above as processing to be executed by the information processing apparatus 500.

The RAM 502 includes an area that can store computer programs and data loaded from the ROM 503 or a nonvolatile memory 504, data received from an image capturing apparatus 100 or a signal transmission/reception unit 220 via an OF 505, and the like. Furthermore, the RAM 502 includes a work area to be used when the CPU 501 is to execute various kinds of processing. In this manner, the RAM 502 can appropriately provide various kinds of areas.

The ROM 503 stores setting data of the information processing apparatus 500, computer programs and data related to the basic operation of the information processing apparatus 500, computer programs and data related to the activation of the information processing apparatus 500, and the like.

The nonvolatile memory 504 stores an OS (Operating System) and computer programs and data for causing the CPU 501 to execute or control each processing described above as processing to be executed by the information processing apparatus 500. The computer programs and data stored in the nonvolatile memory 504 are appropriately loaded to the RAM 502 under the control of the CPU 501 and become processing targets of the CPU 501. Note that the storage unit 590 described above can be implemented by the RAM 502 and the nonvolatile memory 504.

The I/F 505 functions as a communication interface for performing data communication between the image capturing apparatus 100 and the signal transmission/reception unit 220. The CPU 501, the RAM 502, the ROM 503, the nonvolatile memory 504, and the I/F 505 are all connected to a bus 506.

In addition, the numerical values, the processing timings, the processing orders, and the like used in the above description are merely examples that are used for the sake of a more specific explanation, and the present disclosure is not limited to these numerical values, processing timings, processing orders, and the like.

Furthermore, some or all of the embodiments and the modifications described above may be appropriately combined and used. Additionally, some or all of the embodiments and the modifications described above may be selectively used.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, the scope of the following claims are to be accorded the broadest interpretation so as to encompass all such modifications and equivalent structures and functions.

This application claims the benefit of Japanese Patent Application No. 2020-113197, filed Jun. 30, 2020, which is hereby incorporated by reference herein in its entirety.

What is claimed is:

1. An information processing apparatus comprising:
an obtainment unit configured to obtain sensor information which is a result obtained by a sensor, mounted in a mobile robot, sensing an actual space and a position and a posture of the sensor in the sensing;
an estimation unit configured to set, as an index, the sensor information and/or the position and the posture obtained by the obtainment unit and estimate, based on a newly obtained index and an index which has been obtained in the past and is similar to the newly obtained index, a progress status of an operation for obtaining pieces of sensor information including pieces of sensor information of a closed path; and
an output unit configured to output the progress status estimated by the estimation unit.

2. The apparatus according to claim 1, wherein the obtainment unit obtains the position and the posture based on the sensor information.

3. The apparatus according to claim 1, wherein the estimation unit, based on a distance between a latest position obtained by the obtainment unit and a position closest to the latest position, among positions obtained by the obtainment unit, estimates the progress status.

4. The apparatus according to claim 3, wherein a value representing the progress status decreases as the distance increases and increases as the distance decreases.

5. The apparatus according to claim 3, wherein a value representing the progress status indicates a first progress status if the distance is not less than a threshold and indicates a second progress status if the distance is less than the threshold.

6. The apparatus according to claim 1, wherein the estimation unit, based on a similarity between a latest piece of sensor information obtained by the obtainment unit and a piece of sensor information with a highest similarity to the latest piece of sensor information, among pieces of sensor information obtained by the obtainment unit in the past, estimates the progress status.

7. The apparatus according to claim 6, wherein a value representing the progress status increases as the similarity increases and decreases as the similarity decreases.

8. The apparatus according to claim 6, wherein the sensor is an image capturing apparatus configured to captures a captured images of an actual space, and
the similarity includes an SSD (Sum of Squared Difference) between the captured images, an SAD (Sum of Absolute Difference) between the captured images, the number of corresponding feature points between the captured images, and a similarity in corresponding feature point arrangements between the captured images.

9. The apparatus according to claim 6, wherein the sensor is an apparatus configured to collect three-dimensional point groups in an actual space, and the similarity is a result of matching the three-dimensional point groups.

10. The apparatus according to claim 1, wherein the estimation unit, based on a distance between a latest position obtained by the obtainment unit and a position closest to the latest position, among positions obtained by the obtainment unit in the past, and a similarity between a latest piece of sensor information obtained by the obtainment unit and a piece of sensor information with a highest similarity to the latest piece of sensor information, among pieces of sensor information obtained by the obtainment unit in the past, estimates the progress status.

11. The apparatus according to claim 1, wherein the estimation unit, based on a distance between a latest position obtained by the obtainment unit and a predetermined position, estimates the progress status.

12. The apparatus according to claim 1, wherein the estimation unit, based on a similarity between a latest piece of sensor information obtained by the obtainment unit and a piece of sensor information corresponding to a predetermined position, estimates the progress status.

13. The apparatus according to claim 1, wherein the estimation unit, based on a distance between a latest position obtained by the obtainment unit and a predetermined position and a similarity between a latest piece of sensor information obtained by the obtainment unit and a piece of sensor information corresponding to the predetermined position, estimates the progress status.

14. The apparatus according to claim 1, wherein the estimation unit obtains a distance of movement based on a position obtained by the obtainment unit, estimates the progress status in a case in which the distance of movement has exceeded a reference value, and does not estimate the progress status in a case in which the distance of movement has not exceeded the reference value.

15. The apparatus according to claim 1, further comprising:
a generation unit configured to generate, based on the sensor information and the position and the posture obtained by the obtainment unit, map information of an environment.

16. The apparatus according to claim 15, wherein the generation unit generates the map information if a value representing the progress status is not less than a reference value.

17. A mobile robot, comprising:
an information processing apparatus including an obtainment unit configured to obtain sensor information which is a result obtained by a sensor, mounted in the mobile robot, sensing an actual space and a position and a posture of the sensor in the sensing, an estimation unit configured to set, as an index, the sensor information and/or the position and the posture obtained by the obtainment unit and estimate, based on a newly obtained index and an index which has been obtained in the past and is similar to the newly obtained index, a progress status of an operation for obtaining pieces of sensor information including pieces of sensor information of a closed path, and an output unit configured to output the progress status estimated by the estimation unit; and
the sensor.

18. An information processing method, comprising:
obtaining sensor information which is a result obtained by a sensor, mounted in a mobile robot, sensing an actual space and a position and a posture of the sensor in the sensing;
setting the obtained sensor information and/or the obtained position and the posture as an index and estimating, based on a newly obtained index and an index which has been obtained in the past and is similar to the newly obtained index, a progress status of an operation for obtaining pieces of sensor information including pieces of sensor information of a closed path; and
outputting the estimated progress status.

19. A non-transitory computer-readable storage medium storing a computer program for causing a computer to function as perform an information processing method, the method comprising:
obtaining sensor information which is a result obtained by a sensor, mounted in a mobile robot, sensing an actual space and a position and a posture of the sensor in the sensing;
setting the obtained sensor information and/or the obtained position and the posture as an index and estimating, based on a newly obtained index and an index which has been obtained in the past and is similar to the newly obtained index, a progress status of an operation for obtaining pieces of sensor information including pieces of sensor information of a closed path; and
outputting the estimated progress status.
